(19) United States
(12) Patent Application Publication
(10) Pub. No.: US 2006/0179966 A1
(43) Pub. Date: Aug. 17, 2006

(54) Flexible sheath for cables

(76) Inventor: Yung-Pin Kuo, Chang Hwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/048,960

(22) Filed: Feb. 3, 2005

(51) Int. Cl. F16C 1/26

(52) U.S. Cl. 74/502.5

(57) ABSTRACT

A flexible sheath includes a plurality of sections which are pivotably connected head-to-tail. Each section has a first open end and a second open end, and a passage is defined axially through each section. The passage is in communication with the first and second open ends. The first open end of one section is pivotably connected to the second open end of an adjacent section so as to construct a tubular sheath and the brake cable, for example extends through the sheath.

### FIELD OF THE INVENTION

The present invention relates to a flexible sheath through which brake cables or the like movably extending therethrough.

### BACKGROUND OF THE INVENTION

Generally, bicycle brake cables are connected between the brake levers on the handlebar and the brake mechanism and a sheath is used for protection of the brake cables. The sheath is made of plastic material which is flexible so that the brake cables do not in contact with foreign objects so as to prevent to be worn by friction. However, the plastic sheath can be broken easily and the brake cables are then exposed. The brake cables are composed of thin metal wires which are easily broken if the brake cables are not protected by the sheath. Once the thin metal wires are broken they might hurt the users. Besides, the broken wires could penetrate through the sheath and hurt people.

The present invention intends to provide a flexible sheath for cables wherein the flexible sheath is composed of several sections which are pivotably connected with each other.

### SUMMARY OF THE INVENTION

The present invention relates to a flexible sheath which comprises a plurality of sections and each section has a first open end and a second open end. A passage is defined axially through each section and communicates with the first and second open ends. The first open end of one section is pivotably connected to the second open end of an adjacent section so as to form a tubular sheath. The passages of the two adjacent sections are in communication with each other.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the flexible sheath of the present invention;

FIG. 2 is an exploded view to show the flexible sheath of the present invention;

FIG. 3 shows the flexibility of the connection of the sections of the flexible sheath of the present invention;

FIG. 4 shows a cable extends through the flexible sheath of the present invention;

FIG. 5 is a cross sectional view to show the flexible sheath of the present invention with a cable extending therethrough;

FIG. 6 shows the flexibility of the flexible sheath of the present invention;

FIG. 7 shows the brake cable extends through the flexible sheath of the present invention, and

FIG. 8 shows the derailleur cable extends through the flexible sheath of the present invention.

### DETAILED DESCRIPTION OF THE PREFERRED EMBODIMENT

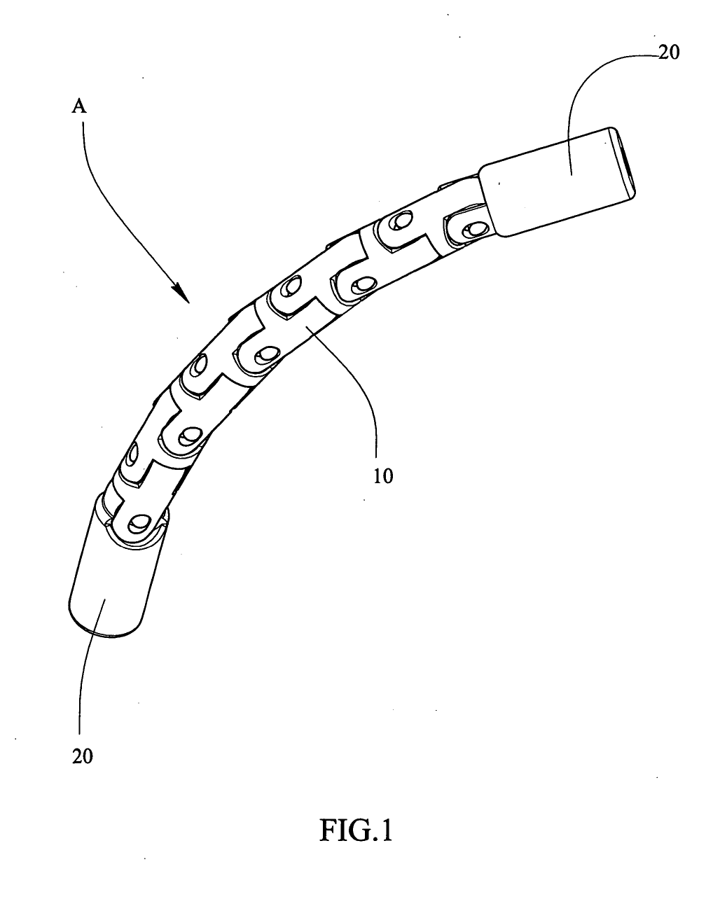

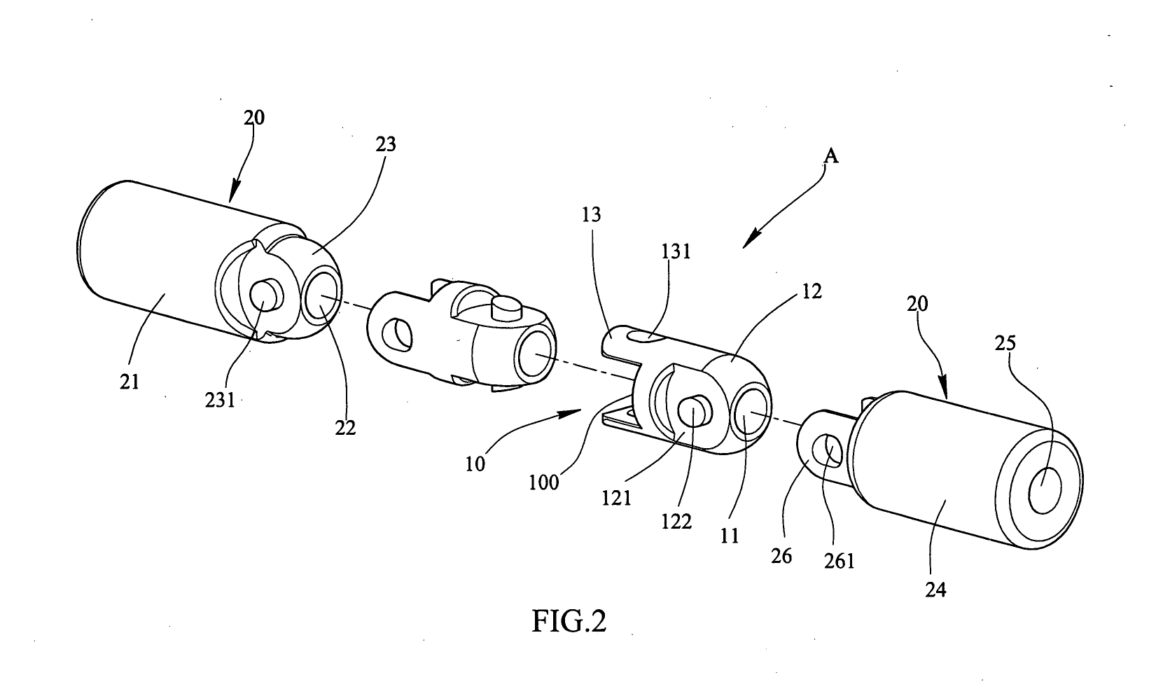

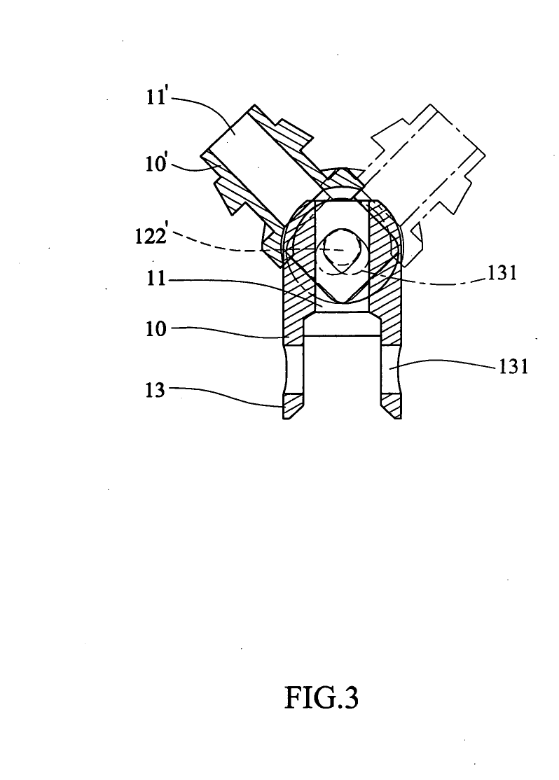

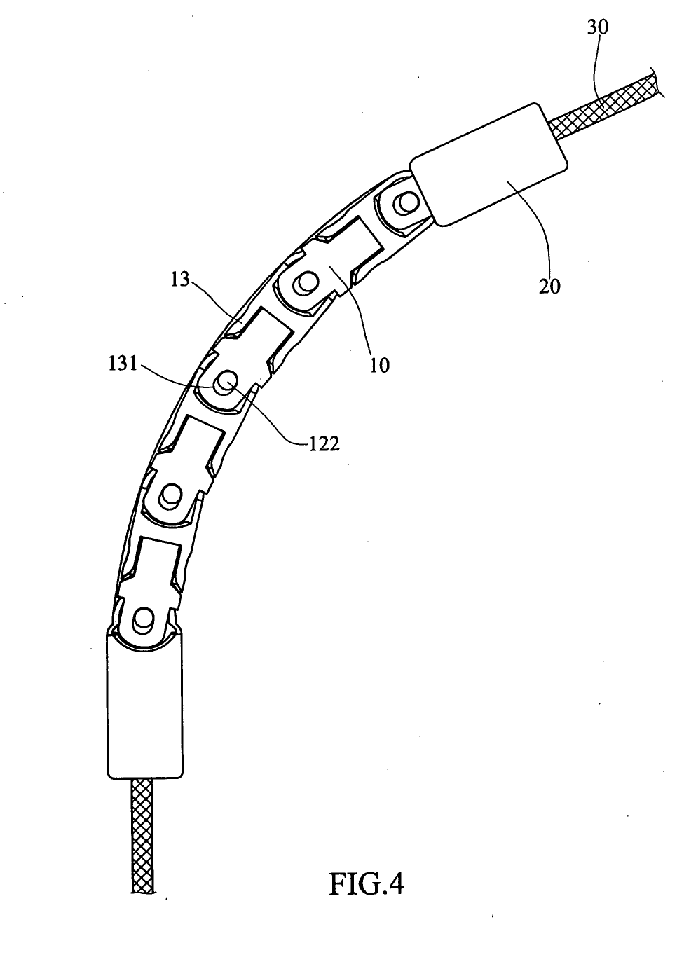

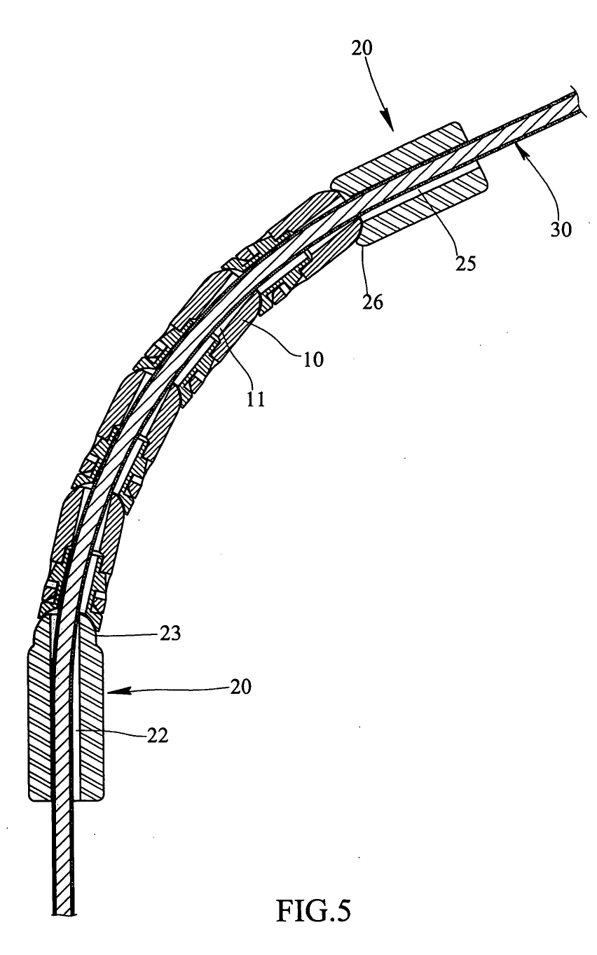

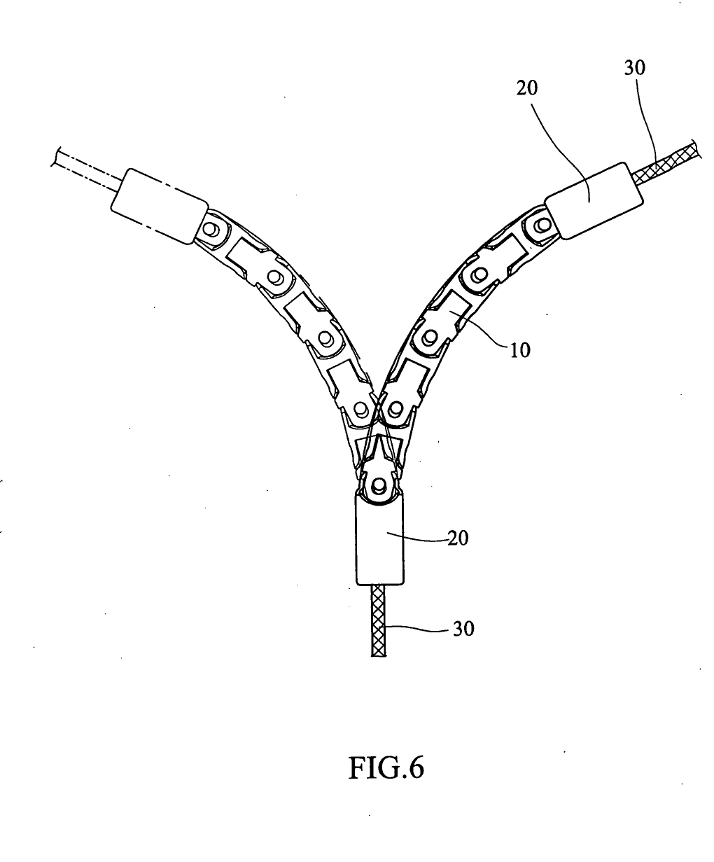

Referring to FIGS. 1 to 6, the flexible sheath “A” of the present invention comprises a plurality of sections 10 which are pivotably connected in a sequence to form a tubular sheath. Each section 10 has a rounded first open end 12 and a second open end 100, and a passage 11 is defined axially through each section 10 and communicates with the first and second open ends 12, 100. By the sheath “A”, a brake cable or derailleur cable 30 as shown in FIGS. 4 and 5 extend through the sheath “A”. The first open end 12 of one section 10 is pivotably connected to the second open end 100 of the adjacent section 10 that is pivotably connected thereto, and the passages 11 of the two adjacent sections 10 are in communication with each other. Two ends 20 are further connected to two ends of the combination of the sections 10. The two ends 20 includes a first end member 21 and a second end member 24 are respectively connected to two ends of the flexible sheath “A”. Each of the first and second end members 21, 24 includes a through hole 22/25 which is in communication with the passages 11 of the sections 10.

The first open end 12 of each section 10 includes two flat surfaces 121 defined in an outer periphery thereof and two protrusions 122 respectively extend from the two flat surfaces 121. Two studs 13 extend from the second open end 100 of each section 10. The first open end 12 is sized to be located between the two studs 13 and two holes 131 are respectively defined through the two studs 13 so that the two protrusions 122 are pivotably engaged with the two holes 131.

The first end member 21 includes a connection end 23 with two flat surfaces and two engaging protrusions 231 extend from the two flat surfaces. The two engaging protrusions 231 are pivotably engaged with the two holes 131 of the two studs 13 of the section 10 that is pivotably connected to the first end member 21. The second end member 24 includes two extensions 26 extending from an end thereof and each extension 26 has a receiving hole 261 defined therethrough. The two protrusions 122 of the first open end 12 of the section 10 that is pivotably connected to the second end member 24 are pivotably engaged with the two receiving holes 261. The brake cable or derailleur cable 30 may have a conventional plastic sheath mounted thereto before it extends through the flexible sheath “A”.

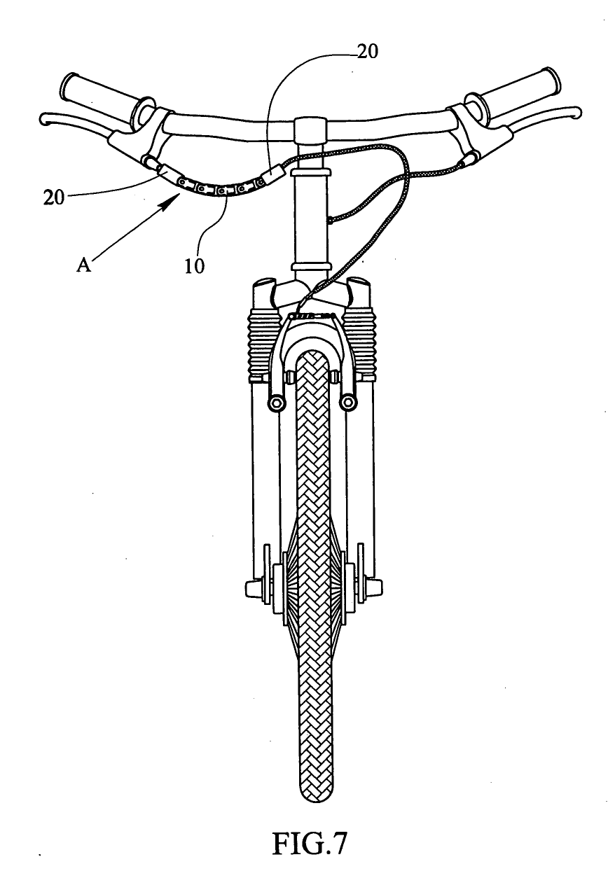

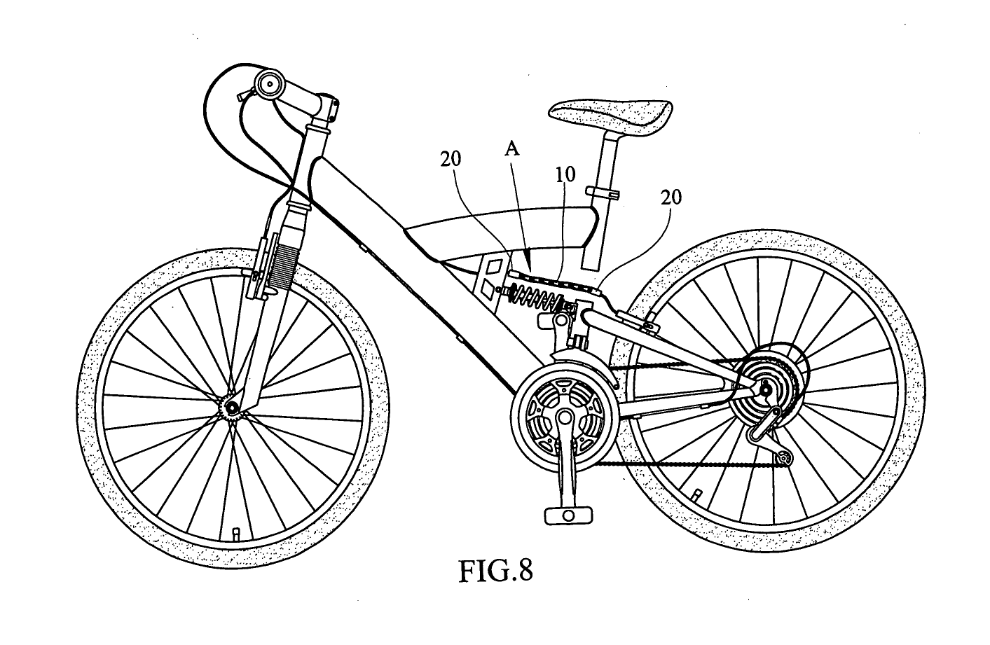

The flexible sheath “A” can be used to receive the brake cable as shown in FIG. 7 or to receive the derailleur cable as shown in FIG. 8.

While we have shown and described the embodiment in accordance with the present invention, it should be clear to those skilled in the art that further embodiments may be made without departing from the scope of the present invention.

What is claimed is:

1. A flexible sheath comprising:
a plurality of sections and each section having a first open end and a second open end, a passage defined axially through each section and communicating with the first and second open ends, the sections being pivotably connected to form a tubular sheath wherein the first open end of one section is pivotably connected to the second open end of the adjacent section that is pivotably connected thereto, the passages of the two adjacent sections being in communication with each other.

2. The flexible sheath as claimed in claim 1, wherein the first open end of each section includes two flat surfaces defined in an outer periphery thereof and two protrusions respectively extend from the two flat surfaces, two studs extending from the second open end of each section, the first open end being sized to be located between the two studs and two holes respectively defined through the two studs so that the two protrusions are pivotably engaged with the two holes.

3. The flexible sheath as claimed in claim 1, wherein a first end member and a second end member are respectively connected to two ends of the flexible sheath, each of the first and second end members includes a through hole in communication with the passages of the sections.

4. The flexible sheath as claimed in claim 3, wherein the first end member includes a connection end with two flat surfaces and two engaging protrusions extend from the two flat surfaces, the two engaging protrusions are pivotably engaged with the two holes of the two studs of the section that is pivotably connected to the first end member.

5. The flexible sheath as claimed in claim 3, wherein the second end member includes two extensions extending from an end thereof, each extension has a receiving hole defined therethrough, the two protrusions of the first open end of the section that is pivotably connected to the second end member are pivotably engaged with the two receiving holes.
